(19) United States
(12) Patent Application Publication
(10) Pub. No.: US 2007/0280807 A1
(43) Pub. Date: Dec. 6, 2007

(54) Lift assembly

(75) Inventors: Stephen W. Threet, (US); Jack T. Mason, (US)

Correspondence Address: DORITY & MANNING, P.A., POST OFFICE BOX 1449, GREENVILLE, SC, 29602-1449, US

(73) Assignee: Everthere Carriers, L.L.C.

(21) Appl. No.: 11/443,480

(22) Filed: May 30, 2006

(51) Int. Cl. B60P 9/00

(52) U.S. Cl. 414/462

(57) ABSTRACT

A lift assembly includes a lift having a housing and an extension device located in the housing in a first state and extendable from the housing in a second state. The lift assembly also includes a bail assembly connected to the extension device, the bail assembly including at least one receiver for receiving a lift apparatus, the receiver defining a first receiver surface and an opposing second receiver surface. The lift assembly further includes a mount adjustably connected to the housing, the mount including a hitch device being configured for connection to a complementary hitch, the hitch device defining a first device surface and an opposing second device surface, the second receiver surface being disposed at or above the second device surface in the first state.

### BACKGROUND OF THE INVENTION

Carrier lifts are used widely to lift and carry items such as wheelchairs, scooters, containers and the like to increase a carrying capacity of a vehicle. For instance, a carrier lift with a platform for carrying a scooter can be mounted to a rear of the vehicle. However, the conventional carrier lift is usually heavy, bulky and unwieldy and therefore is not easily installed or removed from the vehicle. Likewise, the carrier lift is not easily folded out of the way for temporary access, for instance, to a trunk space or to open a tailgate or fifth door of the vehicle. Also, the conventional carrier lift is made for a singular use with its specific platform; thus, the carrier lift cannot be used to carry the scooter on one occasion and a container at some other time.

Moreover, the conventional carrier lift has stability and adaptability problems. Typically, the carrier lift has a single bar or the like, which attaches to a rectangular or ball hitch of the vehicle. When the scooter, for instance, is loaded onto the platform of the carrier lift, the platform is subject to twisting forces as the scooter invariably shifts and moves in reaction to vehicle turns. Specifically, the platform tends to be unstable as it rolls around a horizontal axis formed by the single bar and hitch combination.

In U.S. Pat. No. 4,775,282 Van Vliet attempts to stabilize a platform of a carrier by adding dual vertical uprights to the platform, which are connected to a dual arm frame. The dual arm frame is connected to two horizontal rods, which are inserted in respective receivers of a vehicle. The frame is used specifically for the platform and is not adaptable for other uses and devices other than the platform. Additionally, the dual receivers must be welded to the vehicle instead of using a hitch provided with the vehicle by its maker.

The conventional carrier lift also suffers from ground clearance problems. As shown in U.S. Pat. No. 4,775,282, once a telescoping rod of the carrier is fully retracted, the platform is no higher than the dual receivers that have been painstakingly welded to the vehicle. Accordingly, as the vehicle travels over rough surfaces, troughs and the like, the platform is subject to bottoming out due to its limited, unadjustable ground clearance.

A need exists for a lightweight carrier lift that can be installed easily on a single, original equipment vehicle hitch; that counters twisting forces around the vehicle hitch; that can be temporarily moved away from the tailgate or fifth door without removing the carrier lift from the vehicle; that can be adjusted to accommodate ground clearances of different vehicles; that is modular to accommodate different devices such as a platform or cargo carrier; and that can be easily removed and stored.

### BRIEF SUMMARY OF THE DISCLOSURE

The present invention is generally directed to a lightweight, compact lift assembly, which is easily installed on a vehicle or trailer to an existing hitch to increase carrying capacity of the vehicle or trailer. Due to its light weight and compact size, the lift assembly can be installed by one person. Further, the lift assembly includes one or more receivers that can be positioned above the lowest point of a hitch of the vehicle to increase ground clearance of a cargo carrier or other device that is carried by the lift assembly. The component parts of the lift assembly are economical and easy to manufacture, assemble and use. Other aspects and advantages of the lift assembly are described below.

According to one aspect of the invention, a lift assembly includes a lift having a housing and an extension device, the extension device disposed in the housing in a first state and being configured to extend from the housing in a second state; a bale assembly connected to the extension device, the bale assembly including at least one receiver for receiving a lift apparatus, the receiver defining a first receiver surface and an opposing second receiver surface; and a mount adjustably connected to the housing, the mount including a hitch device being configured for connection to a complementary hitch, the hitch device defining a first device surface and an opposing second device surface.

According to this aspect of the invention, the extension device is in communication with a drive mechanism, the drive mechanism being configured to retract the extension device in the first state and to extend the extension device in the second state.

Also according to this aspect of the invention, the bale assembly includes at least one brace disposed adjacent the first receiver surface, the brace being configured to contact the first receiver surface to counter a torsional force imparted by a load on the lift apparatus to maintain a position of the receiver relative to the housing.

In this aspect, the bale assembly includes at least one brace and at least one pivot disposed proximate the brace, the brace being configured to contact the first receiver surface in the first state, the pivot being configured to incline the receiver in a third state.

Also in this aspect, the brace is spaced apart from the first receiver surface in the first state, the pivot being configured to urge the first receiver surface and the brace apart to counter a torsional force imparted by a load on the lift apparatus to maintain a position of the receiver relative to the housing.

Further in this aspect, at least two braces are provided with at least two pivots, the mount interposed between the braces and the pivots.

In this aspect, the hitch device is one of a ball hitch device or a drawbar.

Also in this aspect, the lift assembly weighs from about thirty pounds to about forty pounds.

Further in this aspect, at least two receivers are provided, the mount interposed between the two receivers.

In this aspect, the mount further includes an adjustable collar assembly, wherein the hitch device is connected to the complementary hitch in a first plane, the adjustable collar assembly being configured to rotate the lift in a second plane transverse to the first plane. In this aspect, the second plane is parallel to a vehicle tailgate.

Also in this aspect, the mount further includes an adjustable mounting piece disposed between the housing and the hitch device, the adjustable mounting piece being configured to adjust the hitch device relative to the receiver.

In this aspect, means for attaching the adjustable mounting piece to the housing are included. The means for attaching is selected from the group consisting of a bolt, a screw, and a cotter key.

Further in this aspect, a cargo carrier being configured for connection to the receiver is provided.

In this aspect, a fork lift device being configured for connection to the receiver can be provided.

Further in this aspect, the second receiver surface is disposed at or above the second device surface in the first state.

In another aspect of the invention, a lift assembly includes a lift including a housing and an extension device, the extension device disposed in the housing in a first state and being configured to extend from the housing in a direction of a ground in a second state; a bale assembly connected to the extension device, the bale assembly including at least two receivers for receiving a lift apparatus, each receiver defining a first receiver surface and an opposing second receiver surface; and a mount connected to the housing and interposed between the two receivers, the mount including an adjustable mounting piece and a hitch device, the adjustable mounting piece disposed between the housing and the hitch device and being configured to adjust the hitch device relative to the receivers, the hitch device being configured for connection to a complementary hitch, the hitch device defining a first device surface and an opposing second device surface, the second receiver surface being disposed at or above the second device surface in the first state.

In this aspect, the bale assembly includes at least two braces and at least two pivots disposed proximate respective ones of the braces, each brace being configured to contact respective ones of the first receiver surfaces in the first state, the pivots being configured to incline the receiver in a third state.

Further in this aspect, each of the braces is spaced apart from the respective first receiver surfaces in the first state, the pivots being configured to urge the first receiver surfaces and the braces apart to counter a torsional force imparted by a load on the lift apparatus to maintain a position of the receivers relative to the housing.

Also in this aspect, a collapsible cargo carrier being configured for connection to the receiver can be provided. The collapsible cargo carrier is configured to occupy a smaller volume in a collapsed position than in an unfolded position.

In this aspect, the mount is adjustably connected to the housing.

In a further aspect of the invention, a lift assembly includes a housing having an extension device disposed in the housing and being configured to extend from the housing; a bale assembly connected to the extension device, the bale assembly including two receivers for receiving a lift apparatus; and a drawbar connected to the housing and to a hitch or the like, the drawbar being disposed between the receivers such that the housing is vertically stationary, e.g., relative to the hitch when the extension device extends from the housing.

In this aspect, the drawbar is vertically adjustable relative to the housing.

Also in this aspect, the hitch is a one and one-quarter inch hitch or a two inch hitch and the drawbar is configured for either, or interchangeable for either.

Further in this aspect, the drawbar is attached to a plate, the plate being vertically adjustable relative to the housing, and being further configured for inversion relative to the housing to change orientation of the drawbar relative to the hitch. The respective lower surfaces of the receivers can be spaced above a bottom surface of the drawbar when the extension device is fully retracted into the housing.

In this aspect, the bale assembly also includes at least two pivots being configured to incline the receivers after the extension device is fully retracted into the housing.

Other aspects and advantages of the invention will be apparent from the following description and the attached drawings, or can be learned through practice of the invention.

### BRIEF DESCRIPTION OF THE DRAWINGS

A full and enabling disclosure of the present invention, including the best mode thereof to one skilled in the art, is set forth more particularly in the remainder of the specification, including reference to the accompanying figures, in which:

FIG. 1 is a perspective view of a lift assembly according to an aspect of the invention installed in an environment for which it is intended to be used;

FIG. 2 is a perspective view of the lift assembly as in FIG. 1 showing various aspects of the lift assembly;

FIG. 3 is a partial, side elevational view of the lift assembly as in FIG. 1;

FIG. 4 is a partial, rear elevational view of the lift assembly as in FIG. 3;

FIG. 5 is another partial, rear elevational view of the lift assembly as in FIG. 3, particularly showing a hitch device in another position relative to a receiver of the lift assembly;

FIG. 6 is a partial, side elevational view of another embodiment of a lift assembly according to a further aspect of the invention;

FIG. 7 is a partial, side elevational view of yet another embodiment of a lift assembly according to another aspect of the invention;

FIG. 8 is a partial, rear elevational view of the lift assembly as in FIG. 7;

FIG. 9 is a perspective view of a device for use with various embodiments of the lift assemblies of the invention;

FIG. 10 is a side elevational view of the lift assembly as in FIG. 1 particularly showing a stage of use of the lift assembly;

FIG. 11 is a side elevational view of the lift assembly as in FIG. 10 showing a workpiece being positioned on a carrier attached to the lift assembly; and

FIG. 12 is a side elevational view of the lift assembly as in FIG. 11 showing another stage of use of the lift assembly in which the workpiece has been elevated and positioned for carrying.

### DETAILED DESCRIPTION OF THE DISCLOSURE

Detailed reference will now be made to the drawings in which examples embodying the present invention are shown. Repeat use of reference characters in the drawings and detailed description is intended to represent like or analogous features or elements of the present invention.

The drawings and detailed description provide a full and detailed written description of the invention and the manner and process of making and using it, so as to enable one skilled in the pertinent art to make and use it. The drawings and detailed description also provide the best mode of carrying out the invention. However, the examples set forth herein are provided by way of explanation of the invention and are not meant as limitations of the invention. The present invention thus includes modifications and variations of the following examples as come within the scope of the appended claims and their equivalents.

The present invention is generally directed to a compact, lightweight, portable lift assembly for use with a trailer or vehicle such as a car or truck to increase the carrying capacity or utility of the vehicle. The lift assembly can include an adjustable lift and a cargo carrier, a forklift device or other utility device. For instance, the cargo carrier can be used with the adjustable lift to lift and carry a wheelchair, a scooter or the like. The cargo carrier can also carry a container, which can be used to carry a variety of items to free trunk space or truck bed space. Moreover, a forklift device can be used to provide the vehicle with a forklift capability.

Although the figures which are about to be described in detail depict a rectangular-shaped lift assembly, the skilled artisan will instantly recognize that the lift assembly is not limited to the exemplary shapes and sizes shown in the figures.

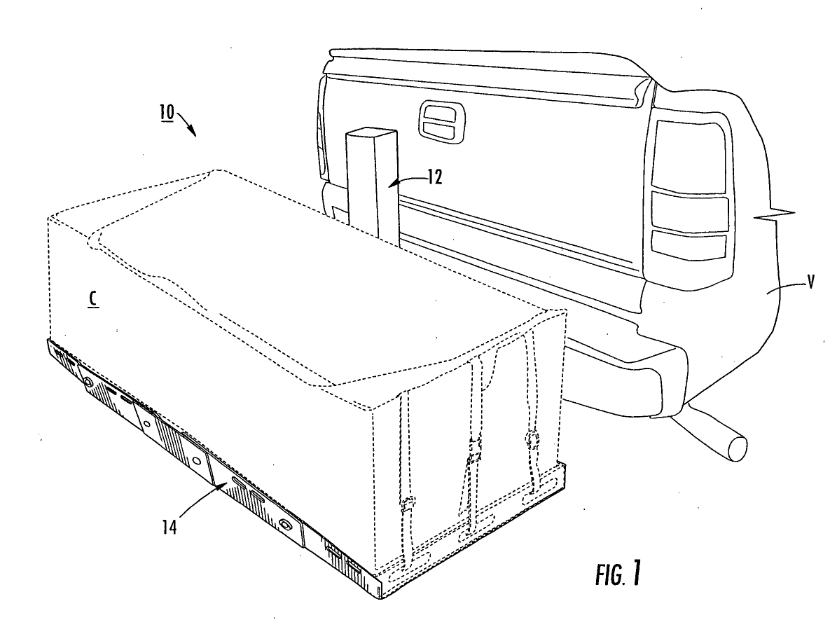

With reference to FIG. 1, the lift assembly is designated in general by the numeral 10 and broadly includes an adjustable lift 12 and a lift apparatus 14, which in this example is a cargo carrier for carrying cargo C. As shown, the adjustable lift 12 is in a first retracted state or stage and attached to a vehicle V to increase a carrying capacity of the vehicle V.

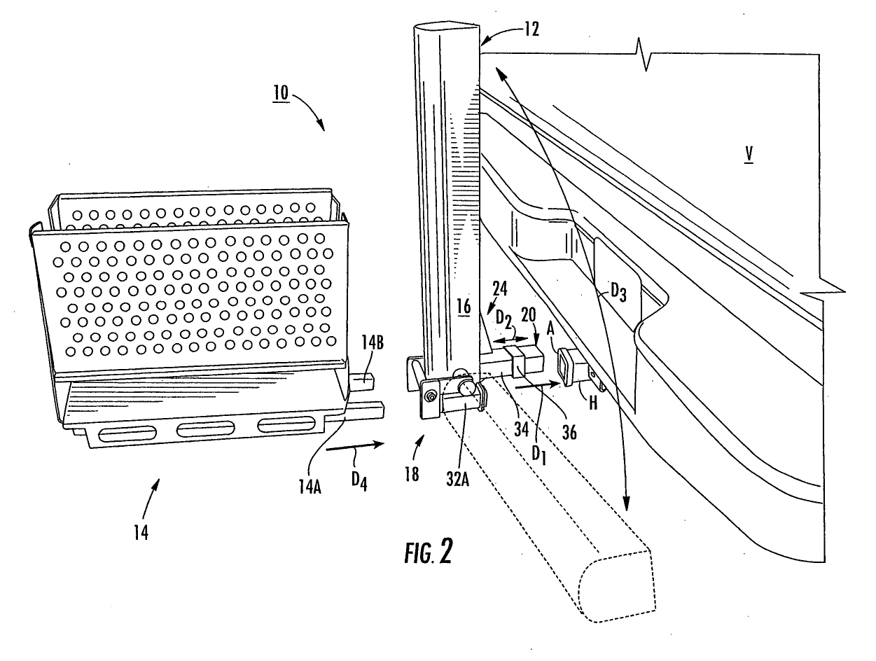

FIG. 2 shows that the adjustable lift 12 generally includes a housing 16, an interface or bale assembly 18 and a drawbar or mount 20. The mount 20 is connected to or is part of an adjustment assembly 24, which connects the mount 20 to the remainder of the adjustable lift 12 and which will be described in greater detail below. As shown, the mount 20 has a complementary hitch device 34, which can be a ball hitch or a drawbar for use with a hitch H of the vehicle V. In this example, the hitch device 34 has an outer circumference, which is smaller than an inner circumference defined by an aperture A of the hitch H. As shown, the hitch device 34 is inserted in a direction indicated by arrow D₁.

Also shown in FIG. 2, the mount 20 further includes an adjustable collar and joint assembly 36, which can be adjusted in multiple directions indicated by a double-headed arrow D₂ to release a detent mechanism (not shown). Release of the detent mechanism rotates the housing 16 in a direction indicated by the double-headed arrow D₃. Thus, the joint assembly 36 is used to rotate the housing 16 away from, for instance, a tailgate of the vehicle V in order to access the bed of the vehicle V without having to remove the adjustable lift 12 each time access to the bed of the vehicle V is required.

FIG. 2 further shows that the bale 18 includes at least one receiver 32A. As shown, the lift apparatus 14 is inserted in a direction of an arrow designated D₄ into the receiver 32A. The receiver 32A and additional receivers will be described in greater detail below with respect to the remaining figures.

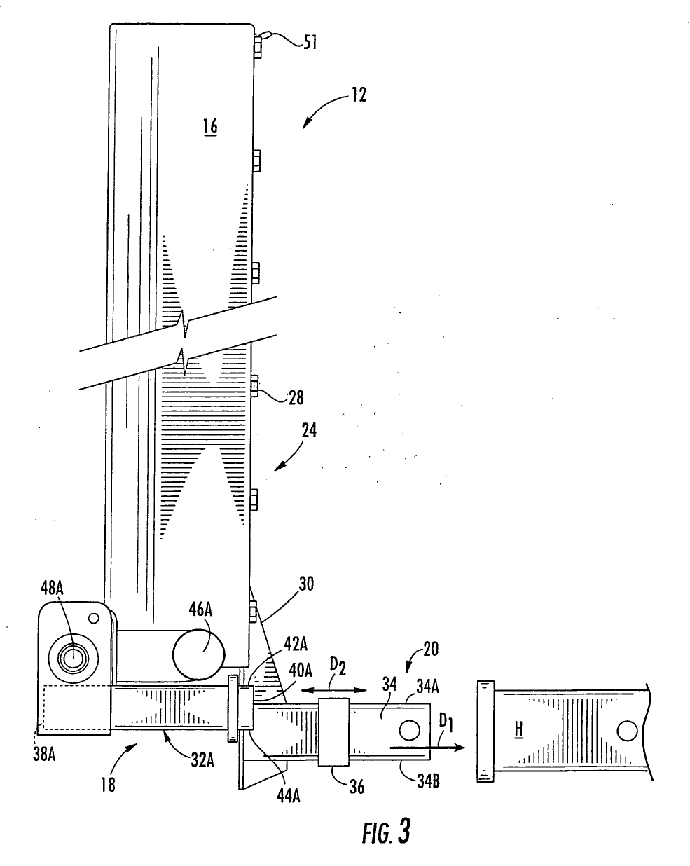

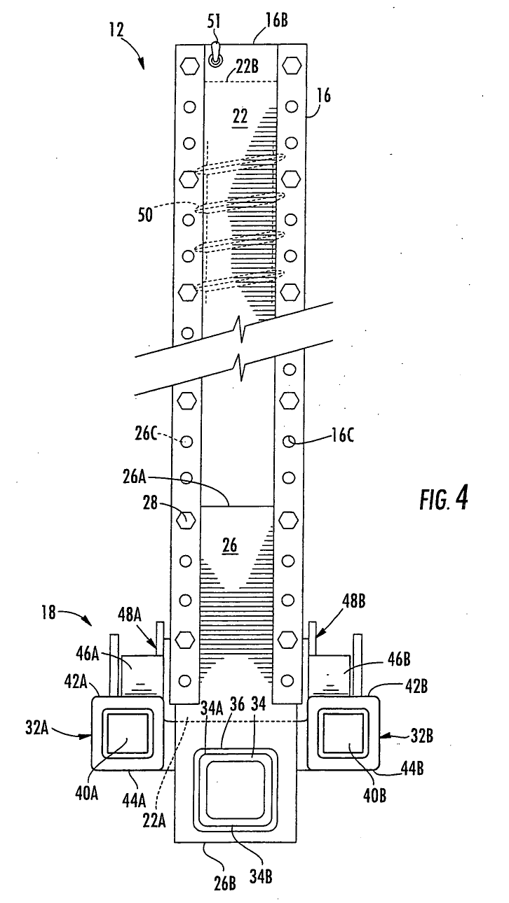

Turning now to FIG. 3, the adjustable lift 12 is shown most clearly in the first stage introduced above. As shown, the housing 16 is connected to the bale 18, and the mount 20 is attached to the adjustment assembly 24. Also as discussed above, the hitch device 34 of the mount 20 is inserted in the hitch H in direction D₁ and attached thereto in a known manner. The hitch device 34 includes a first surface or top surface 34A and an opposing second surface or bottom surface 34B, described in greater detail with respect to FIG. 4 below.

With reference to both FIGS. 3 and 4, the adjustment assembly 24 includes a plate 26 and one or more adjustment devices 28 such as screws, bolts, cotter keys and the like. A structural support 30 is attached to the adjustment assembly 24 and the hitch device 34 to provide structural integrity between the components as will be described below.

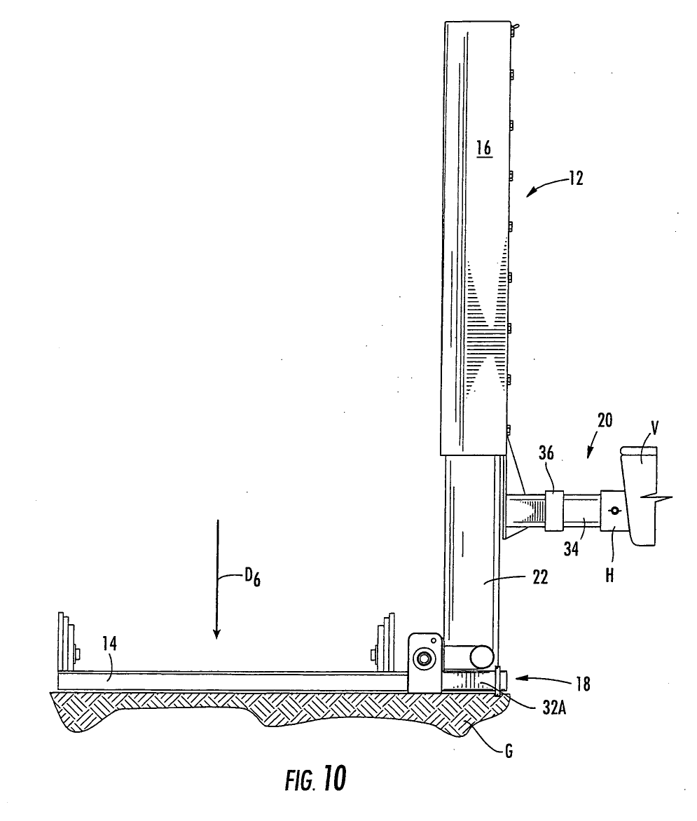

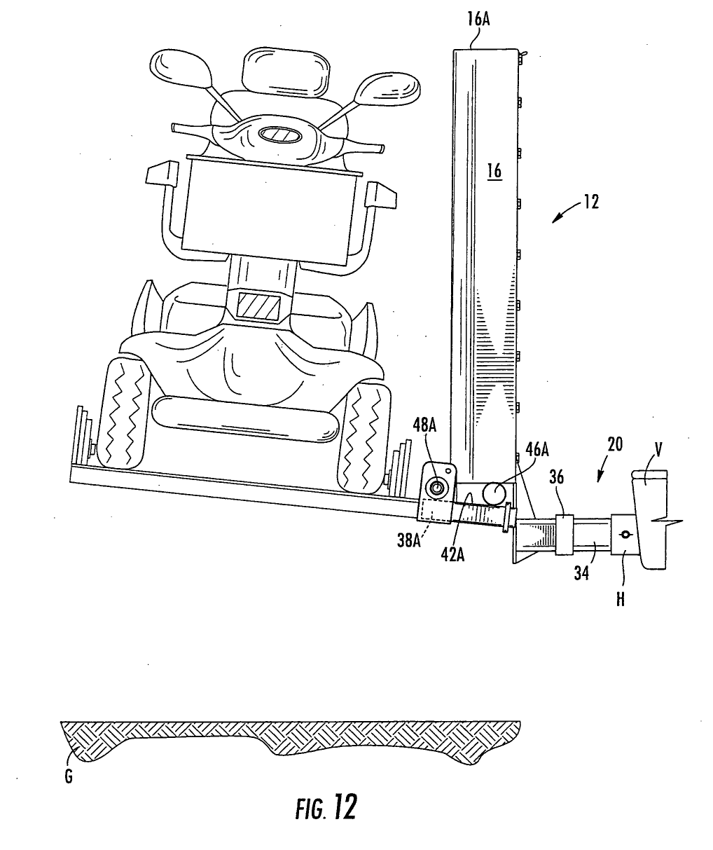

FIG. 3 further shows that the bale 18 includes the receiver 32A, a roll brace or fulcrum 46A and a pivot 48A to which the fulcrum 46A is movably connected. As shown, the receiver 32A has a first opening 38A for receipt of a tine or bar 14A, 14B from the lift apparatus 14 (see also FIG. 2). The receiver 32A further includes a second opening 40A through which the bar 14A, 14B of the lift apparatus 14 may project. The receiver 32A includes a first or top surface 42A and an opposing second or bottom surface 44A. As will be described in greater detail below, the roll brace 46A interacts with the top surface 42A to prevent the adjustable lift 12 from rolling relative to the hitch H. Also shown, the pivot 48A is activated when the roll brace 46A acts as a fulcrum against the top surface 42A when the adjustable lift 12 is taken from the first stage as shown in FIG. 3 into a carrying or third stage as will be described with respect to FIG. 12 below. FIGS. 3 and 4 also show an electrical switch 51 such as a toggle switch, which activates a drive mechanism 50 to change the adjustable lift 12 from the first stage to a second extended stage (see FIG. 10) to the third stage as in FIG. 12. The drive mechanism 50 is shown in phantom in FIG. 4 for clarity and is further described below.

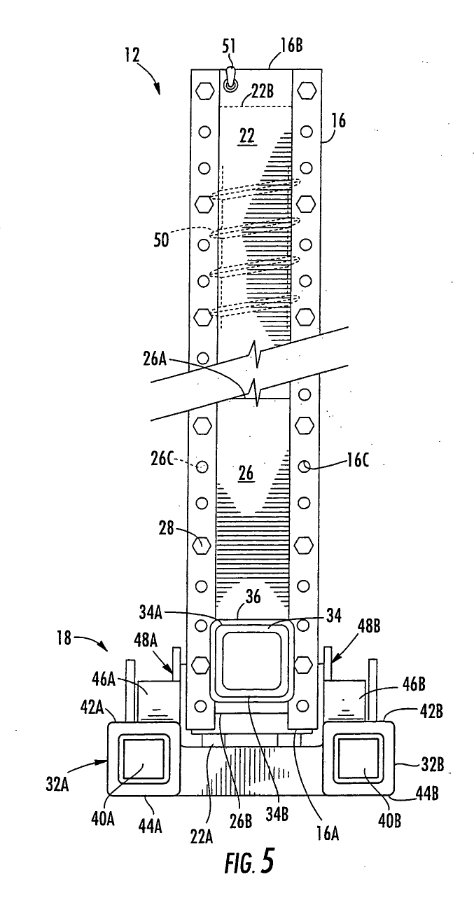

With reference now to FIGS. 4 and 5, the housing 16 includes a lower or first end 16A and an opposing or upper second end 16B. The plate 26 as briefly introduced above with respect to the adjustment assembly 24 also includes an upper or top end 26A and a lower or bottom end 26B, and the complementary hitch device 34 is attached to the plate 26 such as by welding or molding with the plate 26. As shown, the plate 26 includes a plurality of holes 26C and the housing 16 includes a complementary set of holes 16C. A plurality of bolts or other adjustment devices 28 are inserted through the holes 16C and 26C to hold the plate 26 in a desired position. In the example shown in FIG. 4, the bottom 26B of the plate 26 is lower than a bottom 22A of an extension device or tube 22. The extension device 22 also includes a top 22B approximately equal to or less than a height of the housing 16. In this example, the extension device 22 is connected to the drive mechanism 50, which can be a screw drive, a pneumatic device, a hydraulic device or the like. In this example, the drive mechanism 50 is electrically operated by the electrical switch 51 to extend the extension device 22 from the first state as shown to the second extended stage as shown in FIG. 10.

More particularly, as shown in FIG. 4, when the bottom 26B of the plate 26 is lower than the bottom 22A of the extension device 22, the complementary hitch device 34 may be lower than the receivers 32A, 32B. As shown in this example, the two receivers 32A and 32B are located on either side of the complementary hitch device 34, and as noted above, the complementary hitch device 34 includes the first surface 34A and the second surface 34B. The receivers 32A, 32B also have respective first openings 38A,B and second openings 40A,B. A first or top surface 42A,B and a second or bottom surface 44A,B are defined by the first and second openings 38A,B and 40A,B. As shown in FIG. 4, the bottom 26B of the plate 26 and the bottom 34B of the complementary hitch device 34 are lower than the bottom surfaces 44A,B of the receivers 32A,B. Accordingly, when the adjustable lift 12 is inserted in the hitch H as shown in FIG. 3, the bale 18 is somewhat higher than the hitch H, which allows for greater ground clearance of the lift apparatus 14 as discussed further below.

Continuing with reference to FIGS. 4 and 5, the roll brace 46A has a complementary or opposing roll brace 46B, which contacts first surfaces 42A,B of the receivers 32A,B. This arrangement prevents the lift apparatus 14 from rolling clockwise or counterclockwise relative to the hitch H when a load such as cargo C is loaded on the lift apparatus 14 as shown in FIG. 1.

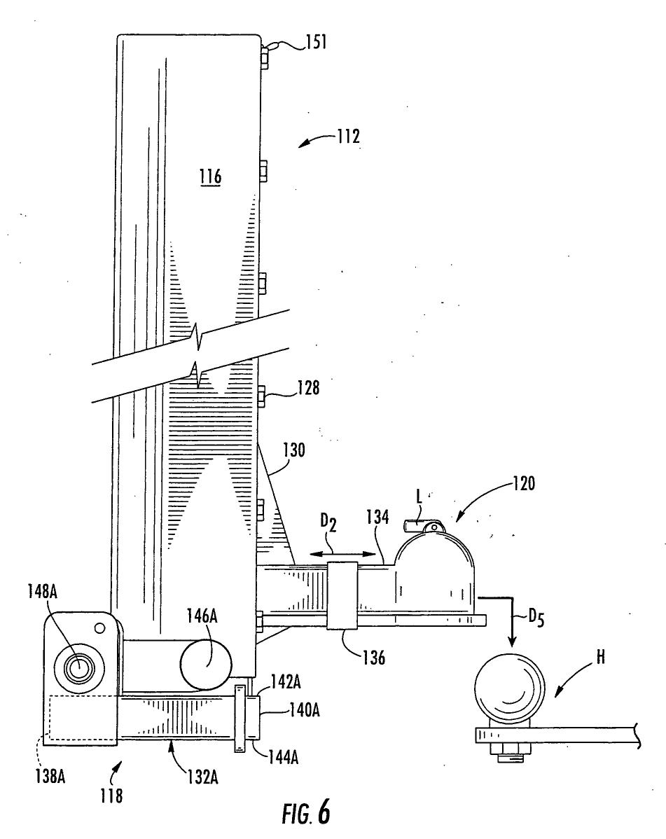

FIG. 6 shows another embodiment of the adjustable lift indicated in this example by the element number 112. Many of the components of the adjustable lift 112 are similar to the components as described above with respect to FIG. 3 and reference is made thereto for an enabling description of these components if not expressly described below. In particular, the mount 120 differs from the mount 20 in that a complementary hitch device 134 is a ball hitch device for use with a ball hitch H as shown. The complementary hitch device 134 is placed onto the ball hitch H as indicated by an arrowhead D₅. A lock L compresses a spring device (not shown) in the hitch device 134 to lock the hitch device 134 against the ball hitch H. The skilled artisan will instantly recognize the use and operation of a ball hitch device and further description is not necessary to understand this aspect of the invention. However, it will be appreciated that an adjustable collar and joint assembly 136 can be moved in the direction D₂ to release the complementary hitch device and access the complementary hitch device 134 to remove the complementary hitch device 134 and replace it with a draw bar type hitch device 34 as described above.

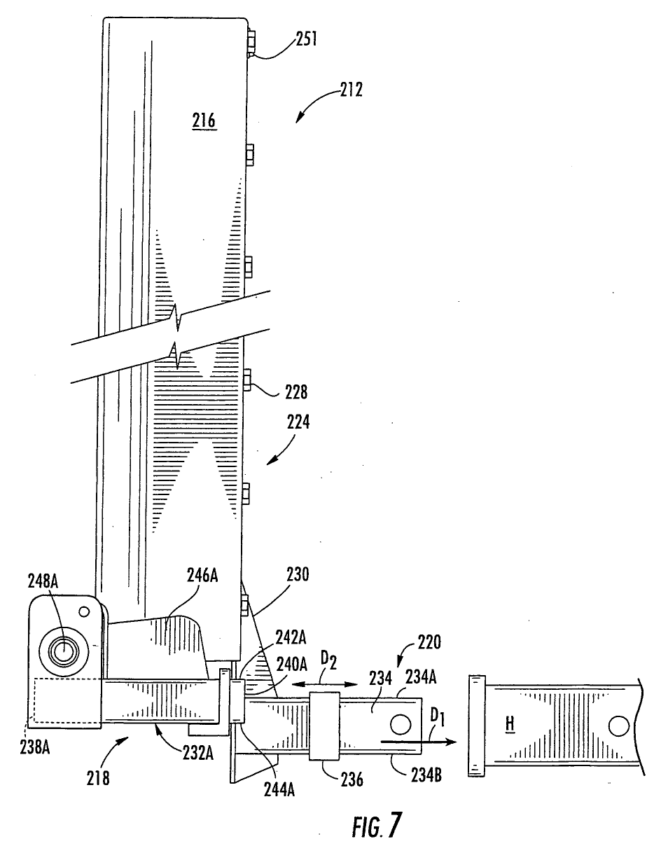

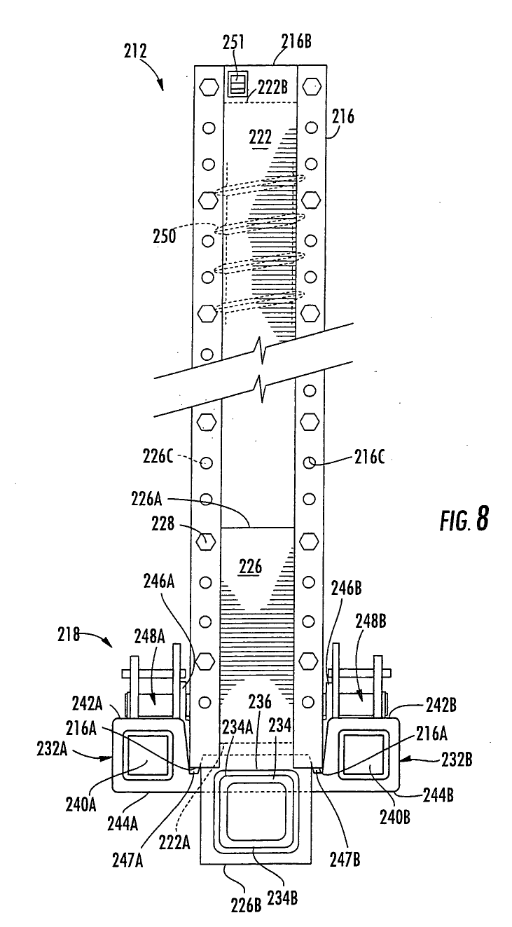

Turning now to FIGS. 7 and 8, yet another embodiment of the present invention is shown, including an alternative aspect to prevent rolling or yawing of an adjustable lift 212 when the lift 212 is in a retracted, carrying state. Once again, many of the components of the adjustable lift 212 are similar to components described above with respect to previous embodiments. Therefore, for the sake of brevity, reference is made to like or similar components not otherwise presently described in order to provide a full and enabling description of the immediate embodiment.

More particularly, receivers 232A, 232B shown in FIGS. 7 and 8 each have respective pockets or guide channels 247A, 247B, which essentially replace the roll braces 46A, 46B described above with respect to FIG. 3. As shown in this aspect of the invention, an electrical button 251 is used to activate a drive mechanism 250 to change stages of the adjustable lift 212. As particularly shown in FIG. 8, as an extension device 222 retracts, lower or first ends 216A of the housing 216 are guided into their respective guide channels 247A, 247B. In this example, the guide channels 247A, 247B are v-shaped to facilitate entry of the first ends 216A. Stated another way, the v-shaped guide channels 247A, 247B are wider at their entry ends and taper together to accommodate any potential lateral offset of the first ends 216A as they enter the channels 247A, 247B. After the first ends 216A have been drawn into the channels 247A, 247B, the channels 247A, 247B provide support in all three axes (x, y, and z) to prevent pitch, roll and yaw of the lift 212 relative to a hitch. Some advantages of this embodiment include a reduction in weight and ease of manufacturing due to fewer parts and material.

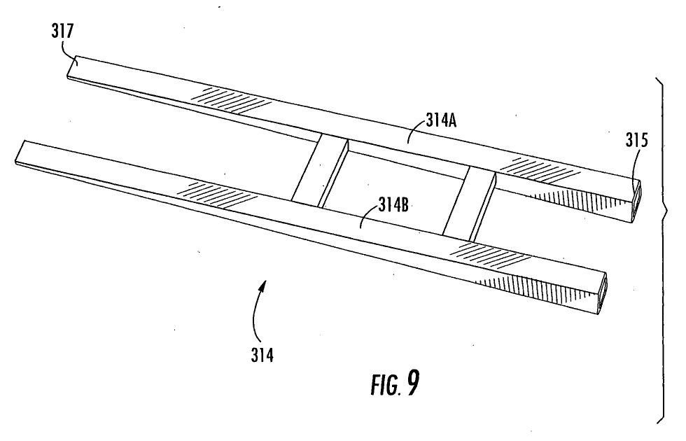

With reference to FIG. 9, an alternative working apparatus 314 is shown, which can be inserted in receivers, such as the receivers 32A,B described above, in order to use the adjustable lift 12 as a forklift. As shown, two tines 314A, 314B each define a proximal end 315 and a distal end 317. The proximal ends 315 are inserted in the receivers 32A, B and the distal ends 317 can be used to pick up a workpiece by the adjustable lift 12 in a known manner.

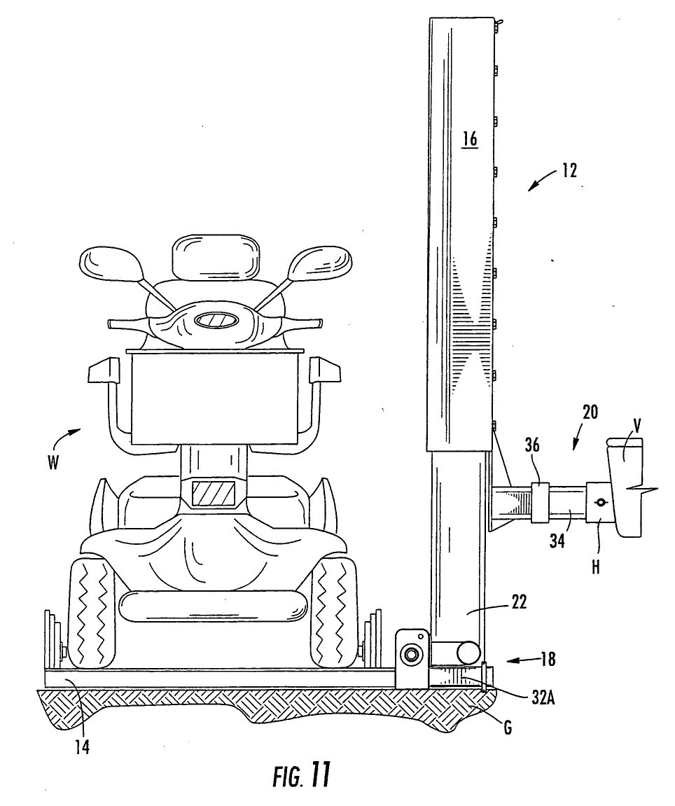

Aspects of the invention may be better understood with reference to FIGS. 10-12 and to an exemplary operation of one embodiment of the invention. Thus, with reference now to FIGS. 10 and 11, a workpiece W, which in this example is a motorized cart, is rolled onto the lift apparatus 14 when the adjustable lift 12 is in the second extended stage. As shown, the extension device 22 extends the adjustable lift 12 into the second stage via the drive mechanism 50 in a direction of ground G as indicated by the arrow D₆ (see also FIG. 4).

As shown in FIGS. 11 and 12, the extension device 22 is raised through the first stage (see also FIG. 3) and passes into the third stage. As shown, the fulcrums 46A,B contact the first surfaces 42A,B of the receivers 32A,B, and the pivot 48A,B cause the receivers 32A,B to tilt. More particularly, as shown in FIG. 12, the first openings 38A,B tilt upward in a direction of the first end 16A of the housing 16. Accordingly, the workpiece W is raised further from the ground G and cradled in a tilted position by the lift assembly 10 such that the workpiece W will not fall from the lift apparatus 14. Additionally, this inclined third stage helps the lift apparatus 14 to avoid “bottoming out” if the vehicle V passes over a depression in the ground G.

As introduced above, the skilled artisan will appreciate that the drawbar or hitch device 34 is vertically adjustable relative to the housing 16. It will also be appreciated that the hitch H can be a standard Class 1, 2, 3, 4 or 5 hitch, such as a one and one-quarter inch or two inch hitch, and therefore, the drawbar 34 can be interchanged for use with these hitches. Furthermore, the plate 26 can be removed and inverted relative to the housing 16 in order to change an orientation of the drawbar 34 relative to the hitch H to provide further height adjustments if desired.

While a variety of embodiments of the invention have been shown and described, those skilled in the art will recognize that the foregoing description is by way of example only and is not intended to limit the invention so further described in the appended claims. Further, the skilled artisan will recognize that a variety of changes and modifications may be made to the foregoing embodiments, including interchanging various aspects of the described embodiments, either in whole or in part, without departing from the spirit and scope of the invention. For example, shapes, material make-up and component placement can be modified to suit particular applications. It is intended to claim all such changes and modifications as fall within the scope of the appended claims and their equivalents.

That which is claimed is:

1. A lift assembly, comprising:
a lift including a housing and an extension device, the extension device disposed in the housing in a first state and being configured to extend from the housing in a second state;
a bale assembly connected to the extension device, the bale assembly including a receiver, the receiver defining a first receiver surface and an opposing second receiver surface; and
a mount adjustably connected to the housing, the mount including a hitch device being configured for connection to a complementary hitch, the hitch device defining a first device surface and an opposing second device surface.

2. The lift assembly as in claim 1, wherein the extension device is in communication with a drive mechanism, the drive mechanism being configured to retract the extension device in the first state and to extend the extension device in the second state.

3. The lift assembly as in claim 1, wherein the bale assembly includes at least one brace disposed adjacent the first receiver surface, the brace being configured to contact the first receiver surface to counter a torsional force imparted by a load on the lift apparatus.

4. The lift assembly as in claim 1, wherein the bale assembly includes at least one brace and at least one pivot disposed proximate the brace, the brace being configured to contact the first receiver surface in the first state, the pivot being configured to incline the receiver in a third state.

5. The lift assembly as in claim 4, wherein the brace is spaced apart from the first receiver surface in the first state, the pivot being configured to urge the first receiver surface and the brace apart to counter a torsional force imparted by a load on the lift apparatus to maintain a position of the receiver relative to the housing.

6. The lift assembly as in claim 4, further comprising at least two braces and at least two pivots, the mount interposed between the braces and the pivots.

7. The lift assembly as in claim 1, further comprising at least two receivers, the mount interposed between the two receivers.

8. The lift assembly as in claim 1, wherein the mount further includes an adjustable collar assembly, wherein the hitch device is connected to the complementary hitch in a first plane, the adjustable collar assembly being configured to rotate the lift in a second plane transverse to the first plane.

9. The lift assembly as in claim 8, wherein the second plane is parallel to a vehicle tailgate.

10. The lift assembly as in claim 1, wherein the mount further includes an adjustable mounting piece disposed between the housing and the hitch device, the adjustable mounting piece being configured to adjust the hitch device relative to the receiver.

11. The lift assembly as in claim 10, further comprising means for attaching the adjustable mounting piece to the housing.

12. The lift assembly as in claim 1, further comprising a fork lift device being configured for connection to the receiver.

13. The lift assembly as in claim 1, wherein the second receiver surface is disposed at or above the second device surface in the first state.

14. A lift assembly, comprising:
a lift including a housing and an extension device, the extension device disposed in the housing in a first state and being configured to extend from the housing in a direction of a ground in a second state;
a bale assembly connected to the extension device, the bale assembly including at least two receivers, each receiver defining a first receiver surface and an opposing second receiver surface; and
a mount connected to the housing and interposed between the two receivers, the mount including an adjustable mounting piece and a hitch device, the adjustable mounting piece disposed between the housing and the hitch device and being configured to adjust the hitch device relative to the receivers.

15. The lift assembly as in claim 14, wherein the hitch device defines a first device surface and an opposing second device surface, the second receiver surface being disposed at or above the second device surface in the first state.

16. The lift assembly as in claim 14, wherein the bale assembly includes at least two braces and at least two pivots disposed proximate respective ones of the braces, each brace being configured to contact respective ones of the first receiver surfaces in the first state, the pivots being configured to incline the receiver in a third state.

17. The lift assembly as in claim 16, wherein each of the braces is spaced apart from the respective first receiver surfaces in the first state, the pivots being configured to urge the first receiver surfaces and the braces apart to counter a torsional force imparted by a load on the lift apparatus to maintain a position of the receivers relative to the housing.

18. The lift assembly as in claim 14, further comprising a collapsible cargo carrier being configured for connection to the receiver, the collapsible cargo carrier being further configured to occupy a smaller volume in a collapsed position than in an unfolded position.

19. A lift assembly, comprising:
a housing having an extension device disposed in the housing and being configured to extend from the housing;
a bale assembly connected to the extension device, the bale assembly including two receivers; and
a drawbar connected to the housing, the drawbar being disposed between the receivers such that the housing is virtually stationary when the extension device extends from the housing.

20. The lift assembly as in claim 19, wherein the drawbar is vertically adjustable relative to the housing.

21. The lift assembly as in claim 19, wherein the drawbar is attached to a plate, the plate being vertically adjustable relative to the housing.

22. The lift assembly as in claim 21, wherein the plate is configured for inversion relative to the housing to change orientation of the drawbar relative to the hitch.

23. The lift assembly as in claim 19, wherein respective lower surfaces of the receivers are spaced above a bottom surface of the drawbar when the extension device is fully retracted into the housing.

24. The lift assembly as in claim 19, wherein the bale assembly includes at least two pivots being configured to incline the receivers after the extension device is fully retracted into the housing.
